(19) United States
(12) Patent Application Publication
(10) Pub. No.: US 2025/0337851 A1
(43) Pub. Date: Oct. 30, 2025

(54) DISPLAY INPUT DEVICE CAPABLE OF SETTING DISPLAY ORDER OF OPERATION BUTTONS AND IMAGE FORMING APPARATUS

(71) Applicant: KYOCERA Document Solutions Inc., Osaka (JP)

(72) Inventors: Toshihiko WATANABE, Osaka (JP); Masato HIRABE, Osaka (JP); Hiroshi NAKAGAWA, Osaka (JP); Toshiya MIYAI, Osaka (JP)

(73) Assignee: KYOCERA Document Solutions Inc., Osaka (JP)

(21) Appl. No.: 19/186,988

(22) Filed: Apr. 23, 2025

(30) Foreign Application Priority Data
Apr. 24, 2024 (JP) 2024-070942

(51) Int. Cl. H04N 1/00; G03G 15/00

(52) U.S. Cl. CPC H04N 1/00517; G03G 15/502; H04N 1/00384; H04N 1/00411; H04N 1/00421; H04N 1/00511; H04N 1/00514; H04N 2201/0094

(57) ABSTRACT

In an image forming apparatus, a controller allows a display device to display operation buttons and executes either one of: a user-specific display mode in which, for each individual one of users, respective user-specific numbers of operations on the operation buttons made by the individual user are measured and, in use by the individual user, an order of display of the operation buttons on the display device for the individual user is set based on the respective user-specific numbers of operations on the operation buttons; and a cross-user display mode in which respective total numbers of operations on the operation buttons made by all the users are measured and, in use by any one of the users, an order of display of the operation buttons on the display device is set based on the respective total numbers of operations on the operation buttons.

### INCORPORATION BY REFERENCE

This application claims priority to Japanese Patent Application No. 2024-070942 filed on Apr. 24, 2024, the entire contents of which are incorporated by reference herein.

### BACKGROUND

The present disclosure relates to: display input devices in which operation buttons are displayed on a display device and to which an instruction associated with each of the operation buttons is input; and an image forming apparatus with the same, and particularly relates to a technique for setting the order of display of a plurality of operation buttons.

A display input device includes a display device and an operation device capable of being operated by a user (for example, a touch panel provided on the screen of the display device), wherein when any one of a plurality of operation buttons, such as icons or soft keys, being displayed on the screen of the display device is operated, the operation on the operation button is detected by the touch panel and a function associated with the operated operation button is performed.

For example, as an information processing apparatus, there is an MFP that receives, from a server computer, usage history information indicating frequency counting of highly used functions on a user-by-user basis and combination information indicating frequency counting of combinations of functions set by various users, stores the usage history information in a usage history management table, and stores the combination information in a combined function management table, wherein when a mode is selected by a logged-in user, some functions highly used by the logged-in user are read from the usage history management table and displayed on a touch panel display, and, upon subsequent selection and determination of one of the displayed functions by the user, functions highly combined with the determined function are read from the combined function management table and displayed as recommendations on the touch panel display, and then a combination of these functions is sent to the server computer. Thus, in association with the function highly selected by an individual logged-in user, a combination of functions known by any other user can be presented.

For another example, there is an image forming apparatus including: a storage device that stores, on a user-by-user basis, usage history of applications or individual functions of the applications; a controller that determines a recommended function for each individual user based on the usage history stored in the storage device; and a notification device that notifies the individual user of the recommended function. Thus, a useful function when used can be recommended to each individual user.

### SUMMARY

A technique improved over the aforementioned techniques is proposed as one aspect of the present disclosure.

A display input device according to an aspect of the present disclosure includes a display device, an input device, and a controller. The display device displays a plurality of operation buttons associated with different functions. The input device is capable of being operated by a plurality of users and accepts an input of an instruction associated with each of the operation buttons displayed on the display device. When the instruction associated with the operation button is input to the input device, the controller executes the function associated with the operation button. The controller controls display of the display device in either one of: a user-specific display mode in which, for each individual one of the users, respective user-specific numbers of operations on the operation buttons made by the individual user are measured and an order of display of the operation buttons on the display device for the individual user is set based on the measured respective user-specific numbers of operations on the operation buttons; and a cross-user display mode in which respective total numbers of operations on the operation buttons made by all the users are measured and an order of display of the operation buttons on the display device is set as a common order of display among all the users based on the measured respective total numbers of operations on the operation buttons.

An image forming apparatus according to another aspect of the present disclosure includes the display input device according to the one aspect of the present disclosure and an image forming device that forms an image on a recording paper sheet.

### BRIEF DESCRIPTION OF THE DRAWINGS

FIG. 1 is a cross-sectional view showing an image forming apparatus to which a display input device according to one embodiment of the present disclosure is applied.

FIG. 2 is a block diagram showing an essential internal configuration of the image forming apparatus according to the embodiment.

FIGS. 3A and 3B are views showing examples of a home screen displayed on a display device of the image forming apparatus.

FIG. 4 is a view showing an example of a sub-setting screen displayed on the display device of the image forming apparatus.

FIG. 5 is a view showing an example of a second sub-setting screen displayed on the display device of the image forming apparatus.

FIG. 6 is a view showing another example of a second sub-setting screen displayed on the display device of the image forming apparatus.

FIG. 7 is a view conceptually showing data tables in each of which respective user-specific numbers of operations on operation buttons by a user and other data are stored.

FIG. 8 is a view conceptually showing data tables in each of which respective total numbers of operations on operation buttons by all users and other data are stored.

FIG. 9A is a flowchart showing a control procedure for selecting and executing either one of a user-specific display mode and a cross-user display mode.

FIG. 9B is a flowchart showing a control procedure continued from that shown in FIG. 9A.

FIG. 9C is a flowchart showing another control procedure continued from that shown in FIG. 9A.

FIG. 10 is a view showing an example of a home screen displayed on the display device of the image forming apparatus.

FIG. 11 is a view conceptually showing a data table in which respective user-specific numbers of operations on operation buttons by a user, arbitrary fixed places in an order of the operation buttons, and other data are stored.

FIG. 12 is a view showing an example of a home screen displayed on the display device of the image forming apparatus.

### DETAILED DESCRIPTION

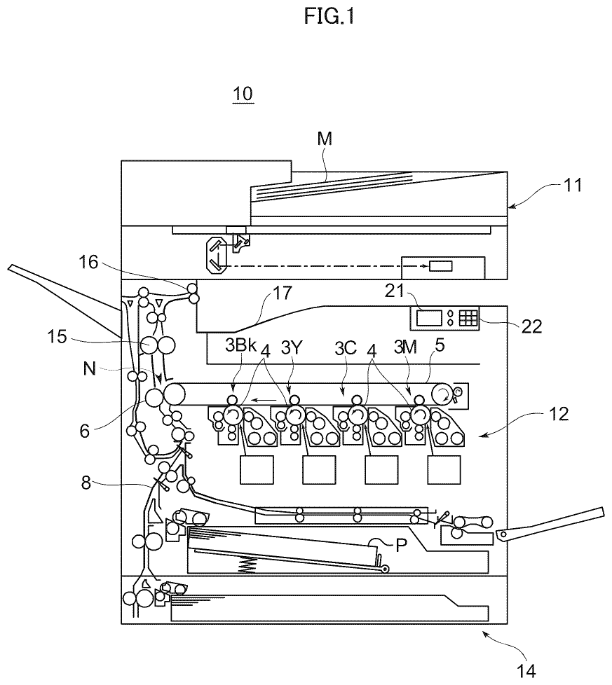

Hereinafter, a description will be given of embodiments of the present disclosure with reference to the drawings. FIG. 1 is a cross-sectional view showing an image forming apparatus to which a display input device according to one embodiment of the present disclosure is applied. As shown in FIG. 1, an image forming apparatus 10 according to this embodiment is an MFP (multifunction peripheral) having multiple functions including, for example, a copy function, a print function, and a facsimile function. The image forming apparatus 10 includes an image reading device 11 and an image forming device 12.

The image reading device 11 includes an image pickup device capable of optically reading an image of an original document, wherein an analog output of the image pickup device is converted to a digital signal and, thus, image data representing the image of the original document is generated.

The image forming device 12 forms the image of the original document on a recording paper sheet and includes an image forming unit 3M for magenta, an image forming unit 3C for cyan, an image forming unit 3Y for yellow, and an image forming unit 3Bk for black. Each of these image forming units 3M, 3C, 3Y, and 3Bk uniformly charges the surface of a photosensitive drum 4, exposes the surface of the photosensitive drum 4 to light to form an electrostatic latent image on the surface of the photosensitive drum 4, develops the electrostatic latent image on the surface of the photosensitive drum 4 into a toner image, and primarily transfers the toner image on the surface of the photosensitive drum 4 to an intermediate transfer belt 5. Thus, a multicolor toner image is formed on the intermediate transfer belt 5. This multicolor toner image is secondarily transferred, at a nip region N between the intermediate transfer belt 5 and a secondary transfer roller 6, to a recording paper sheet P conveyed from a sheet feed device 14 via a conveyance path 8.

Thereafter, heat and pressure are applied to the recording paper sheet P by a fixing device 15 and, thus, the toner image on the recording paper sheet P is fixed by heat and pressure. Then, the recording paper sheet P is ejected through an ejection roller 16 to a sheet output tray 17.

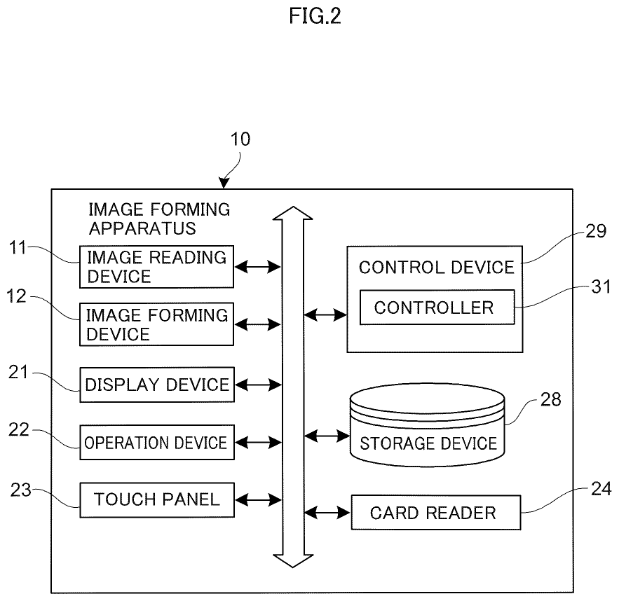

FIG. 2 is a block diagram showing an essential internal configuration of the image forming apparatus 10 according to this embodiment. As shown in FIG. 2, the image forming apparatus 10 includes the image reading device 11, the image forming device 12, a display device 21, an operation device 22, a touch panel 23, a card reader 24, a storage device 28, and a control device 29. These components are operable to transfer data or signals to and from each other via a bus.

The display device 21 is formed of a liquid crystal display (LCD), an organic EL (organic light-emitting diode (OLED)) display or the like. The operation device 22 includes physical keys, including numeric keys, an Enter key, and a Start key.

The touch panel 23 is provided over the screen of the display device 21. The touch panel 23 is a touch panel of a so-called resistive film system or a capacitance system, detects a touch on the touch panel 23 with a user's finger or the like, together with a point of the touch, and outputs a detection signal indicating the coordinate of the point of touch to a below-described controller 31 of the control device 29 and so on. The touch panel 23 serves as an input device through which a user's operation (gesture) made on the screen of the display device 21 is input. The touch panel 23 is capable of being operated by a plurality of users and accepts an input of an instruction associated with each of the operation buttons displayed on the display device 21 and operated by any of the users.

The card reader 24 reads, from an ID card of an individual user, a piece of identification information YD of the user.

The storage device 28 is a large storage device, such as an SSD (solid state drive) or an HDD (hard disk drive), and holds various types of application programs and various types of data.

The control device 29 is made up of a processor, a RAM (random access memory), a ROM (read only memory), and so on. The processor is, for example, a CPU (central processing unit), an ASIC (application specific integrated circuit), an MPU (micro processing unit) or the like. When a control program stored in the above ROM or the storage device 28 is executed by the above processor, the control device 29 functions as the controller 31.

The control device 29 performs the overall control of the image forming apparatus 10. The control device 29 is connected to the image reading device 11, the image reading device 12, the display device 21, the operation device 22, the touch panel 23, the card reader 24, the storage device 28, and so on and performs the operation control of these components and signal or data transfer to and from each of these components.

The controller 31 serves as a processor that executes various types of processing necessary for image formation by the image forming apparatus 10. Furthermore, the controller 31 accepts, based on a detection signal output from the touch panel 23 or an operation made on a physical key of the operation device 22, an operating instruction input by the user. For example, the controller 31 accepts through the touch panel 23 an instruction associated with a touch gesture on a GUI (graphical user interface) or the like displayed on the screen of the display device 21. The controller 31 also has the function of controlling the display operation of the display device 21.

Moreover, the controller 31 acquires the piece of identification information YD of the user read by the card reader 24 and approves a login of the user when the read piece of identification information YD of the user is identical with one of respective pieces of identification information YD of a plurality of users previously stored in the storage device 28.

When, on the image forming apparatus 10 configured as thus far described, the user operates the operation device 22 or the touch panel 23 to select a copy function, an instruction to execute the copy function is input to the operation device 22 or the touch panel 23. In accordance with the input instruction to execute the copy function, the controller 31 allows the image reading device 11 to read an image of an original document and allows the image forming device 12 to record the image of the original document on a recording paper sheet.

Furthermore, the image forming apparatus 10 executes, with its increasing range of functions, any one of a plurality of functions selected by the user. The controller 31 allows the display device 21 to display a plurality pages (including a home screen) in each of which a plurality of operation buttons for use in accepting instructions to execute the respective functions are arranged. When any one of the operation buttons is operated by the user, the controller 31 accepts through the touch panel 23 an instruction to execute the function associated with the operated button and executes the function indicated by the instruction to execute.

The operation buttons are icons or soft keys. The plurality of functions include, in addition to the copy function, saving of image data representing the image of the original document, facsimile communication of the image data, and sending of an e-mail with the image data attachment.

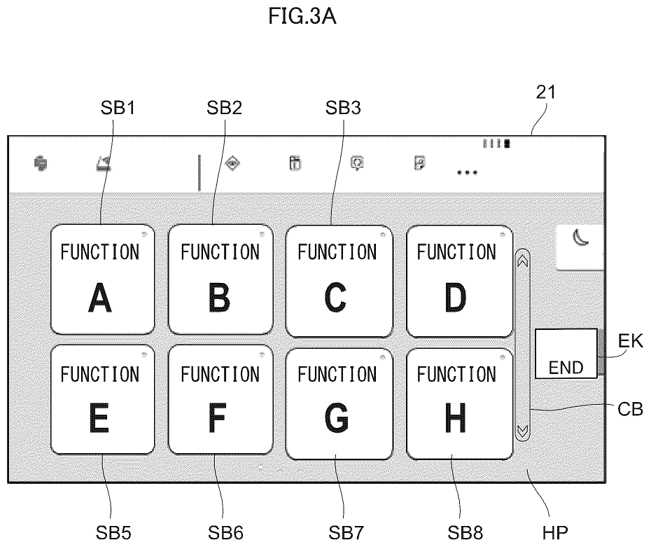

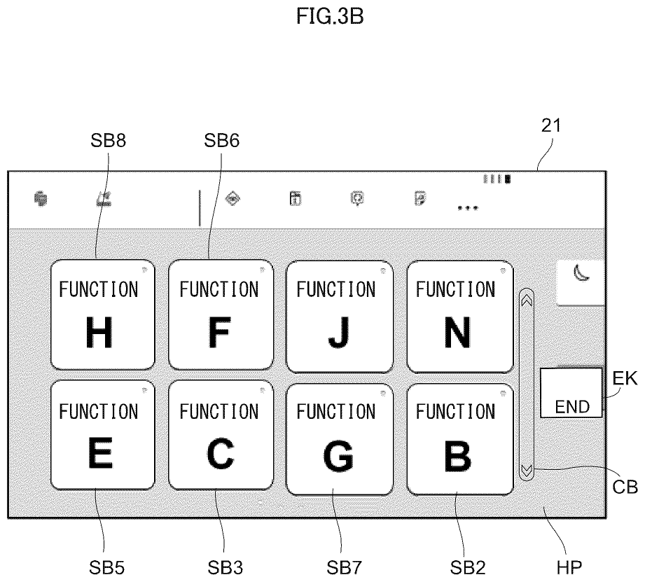

For example, in allowing the display device 21 to display a home screen HP as shown in FIG. 3A, the controller 31 allows the display device 21 to display the respective operation buttons SB1, SB2, . . . in array on the home screen HP. The controller 31 allows the display device 21 to display on the display screen a predetermined number of (eight in this example) operation buttons out of a plurality of operation buttons subject to being displayed thereon. When detecting through the touch panel 23 a user's touch gesture on a scroll bar CB, the controller 31 allows the display device 21 to scroll the screen and further display other operation buttons subject to being displayed.

When the user makes a touch gesture on any one of the operation buttons while the plurality of operation buttons are displayed on the display device 21, the controller 31 accepts through the touch panel 23 an instruction associated with the operation button and executes the function indicated by the instruction.

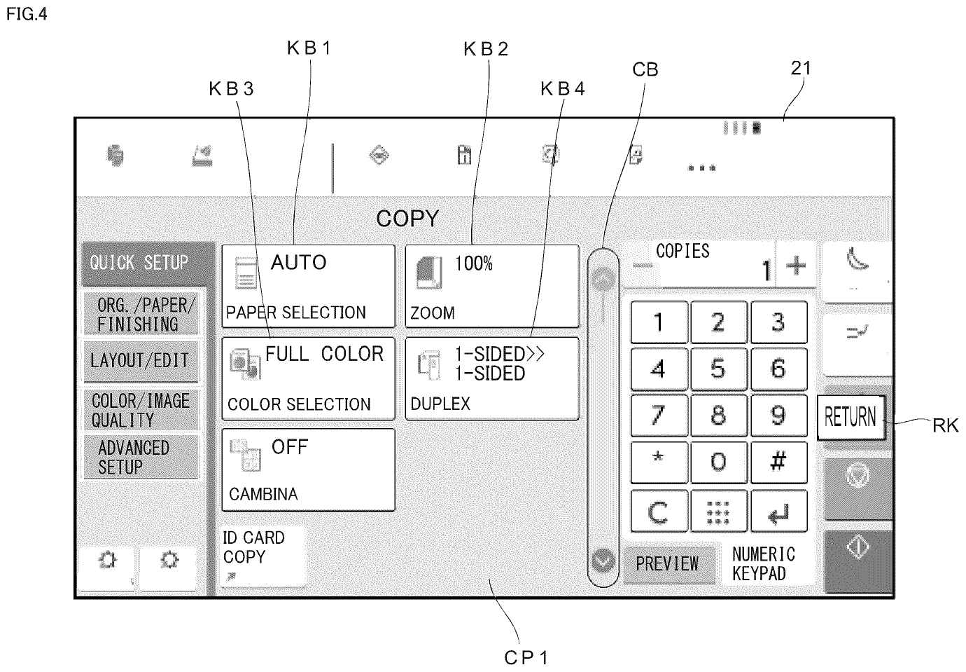

For example, in the case where the function associated with the operation button SB1 on the home screen HP is to display a setting screen CP1 subordinated to the home screen HP (hereinafter, referred to as a sub-setting screen CP1) as shown in FIG. 4, when the controller 31 accepts through the touch panel 23 a screen transition instruction to make transition of screens based on a touch gesture on the operation button SB1, it allows the display device 21 to display, in accordance with the screen transition instruction, the sub-setting screen CP1 shown in FIG. 4.

The sub-setting screen CP1 shown as an example in FIG. 4 displays, for example, a plurality of operation buttons KB1, KB2, . . . , which are subordinated to the operation button SB1 on the home screen HP, in array and also displays a scroll bar CB for use in instructing to provide a scrolling display of the operation buttons KB1, KB2, . . . . When the user makes a touch gesture on any one of the operation buttons on the setting screen CP1, the controller 31 accepts through the touch panel 23 an instruction associated with the operation button and executes the function indicated by the operation button.

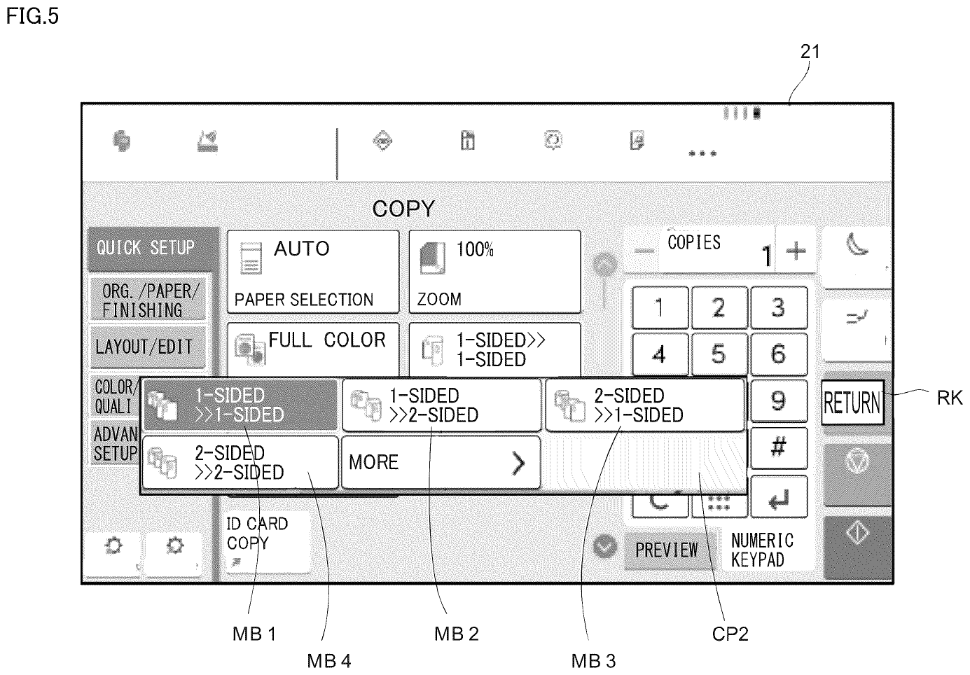

For example, in the case where the function associated with the operation button KB4 is to display a second sub-setting screen CP2 subordinated to the sub-setting screen CP1 as shown as an example in FIG. 5, when the controller 31 accepts through the touch panel 23 an instruction associated with the sub-operation button KB4, it executes the display of the second sub-setting screen CP2, which is a function associated with the operation button KB4, to allow the display device 21 to display the second sub-setting screen CP2 shown as an example in FIG. 5.

The second sub-setting screen CP2 shown in FIG. 5 displays a plurality of operation buttons MB1, MB2, . . . , which are subordinated to the sub-operation button KB4 on the sub-setting screen CP1, in array. For example, when the user makes a touch gesture on the second sub-operation button MB1, the controller 31 accepts through the touch panel 23 an instruction associated with the operation button MB1 and executes, for example, processing for selecting one-sided printing, which is the function indicated by the instruction.

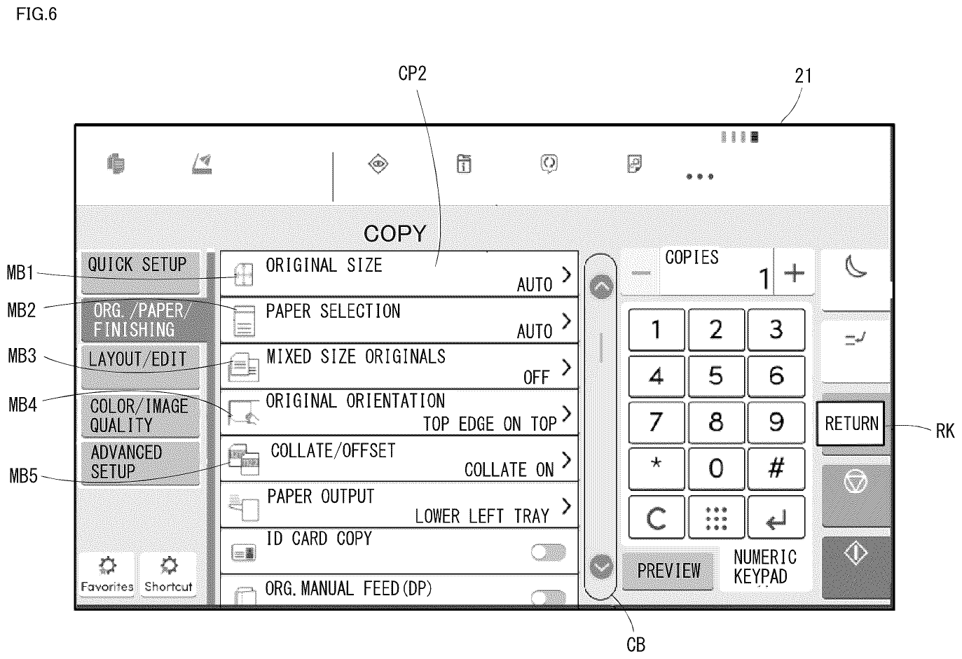

For another example, in the case where the function associated with the sub-operation button KB2 is to display a second sub-setting screen CP2 as shown in FIG. 6, when the controller 31 accepts through the touch panel 23 an instruction associated with the sub-operation button KB2, it executes the function associated with the sub-operation button KB2 to allow the display device 21 to display the second sub-setting screen CP2 shown as an example in FIG. 6.

The second sub-setting screen CP2 shown in FIG. 6 displays a plurality of second sub-operation buttons (operation keys) MB1, MB2, . . . , which are subordinated to the sub-operation button KB2, in array and also displays a scroll bar CB for use in instructing to provide a scrolling display of the second sub-operation buttons MB1, MB2, . . . . For example, when the user makes a touch gesture on the second sub-operation button MB1, the controller 31 accepts through the touch panel 23 an instruction associated with the second sub-operation button MB1 and executes processing for selecting and setting the original size, which is the function indicated by the instruction.

As thus far described, the image forming apparatus 10 has a wide variety of functions, which requires a large number of operation buttons subject to being displayed. Therefore, the order of display of operation buttons on the screen should preferably be appropriately set for each of the home screen and setting screens to be displayed on the display device 21. For example, the order of display of operation buttons on the home screen may be set for each of users logged in to the image forming apparatus 10 and according to each user's preference.

However, in the image forming apparatus 10 shared by many and unspecified persons, user's login may be omitted. In this case, the order of display of operation buttons on each of the home screen and setting screens cannot be set for each of users and according to each user's preference. In addition, if an individual person sets the order of display of operation buttons to be displayed on the display device 21 according to the individual's preference, this makes it hard for the other persons to use the operation buttons. Furthermore, even if a means for setting the order of display of operation buttons on each of the home screen and setting screens according to each user's preference is provided, the operation for using this means is bothersome.

To cope with this, in this embodiment, upon respective executions of the functions indicated by instructions associated with individual operation buttons operated by the users, the controller 31 measures, on a user-by-user basis, the respective user-specific numbers of operations YN on the operation buttons. Then, while the user logs in to the image forming apparatus 10, the controller 31 controls the display of the display device 21 in a user-specific display mode in which the order of display of operation buttons on each of the home screen and setting screens being displayed on the display device 21 is set to an order of display based on the respective measured user-specific numbers of operations YN on the operation buttons, such as the descending order of user-specific number of operations.

Furthermore, the controller 31 measures the respective total numbers of operations TN on the operation buttons made by all the users. While any user does not log in to the image forming apparatus 10, i.e., when a plurality of users share the image forming apparatus 10, the controller 31 controls the display of the display device 21 in a cross-user display mode in which the order of display of operation buttons on each of the home screen and setting screens is set to an order of display based on the respective measured total numbers of operations TN on the operation buttons, such as the descending order of total number of operations. The controller 31 selectively executes the user-specific display mode and the cross-user display mode in accordance with an instruction from each individual user.

In the case where the user-specific display mode is executed, when a user logs in to the image forming apparatus 10, the order of display of operation buttons on each of the home screen and setting screens is set based on the respective user-specific numbers of operations YN on the operation buttons made by the user. Therefore, the home screen becomes user-friendly for the user.

On the other hand, in the case where the cross-user display mode is executed, when a plurality of users share the image forming apparatus 10, the order of display of operation buttons on each of the home screen and setting screens is set based on the respective total numbers of operations TN on the operation buttons made by all the users. Therefore, the home screen and the setting screens are user-friendly for every user. For example, for each individual one of operation buttons on the home screen HP as shown in FIG. 3B, the total number of operations TN on the operation button is measured. Then, the place of each operation button in the order of display of the operation buttons is set based on the measured total number of operations TN on the operation button.

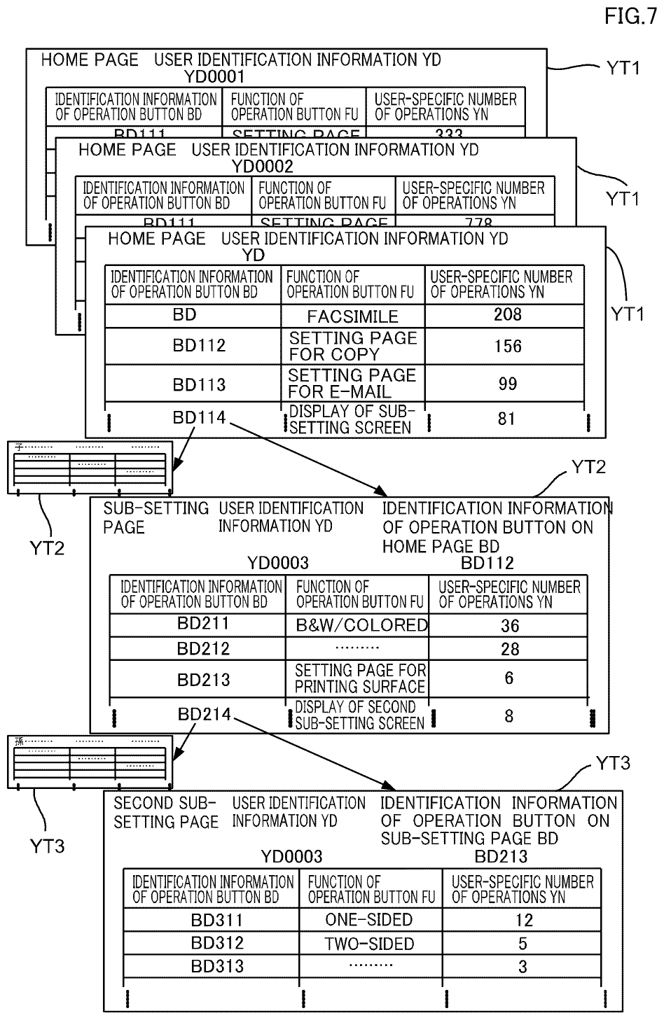

When, in the manner described above, the controller 31 measures, on a user-by-user basis, the respective user-specific numbers of operations YN on the operation buttons on the home screen HP made by the user, the controller 31 creates respective data tables YT1 for individual users as shown as an example in FIG. 7 and allows the storage device 28 to store these data tables YT1. The elements written to each of the data tables YT1 include a piece of identification information YD of the individual user, respective pieces of identification information BD of the operation buttons, the respective functions FU of the operation buttons, and the respective user-specific numbers of operations YN on the operation buttons. When the piece of identification information YD of a user is read by the card reader 24 and the controller 31 approves the login of the user, the controller 31 reads the data table YT1 to which the piece of identification information YD of the user is written, and allows the display device 21 to display the home screen HP. When, based on an operation on an operation button on the home screen HP, the controller 31 accepts through the touch panel 23 an instruction associated with the operation button, the controller 31 determines the piece of identification information BD of the operation button and reads from the read data table YT1 the function FU associated with the piece of identification information BD of the operation button. Then, the controller 31 executes the read function. To sum it up, when accepting an instruction associated with an operation button, the controller 31 executes the function associated with the instruction. After executing the function, the controller 31 counts up and updates the user-specific number of operations YN on the operation button in the data table YT1. In this manner, the respective user-specific numbers of operations YN on the operation buttons on the home screen HP made by the user are measured.

Furthermore, in the case where the display of a sub-setting screen CP1 is set as the function FU of an operation button in the data table YT1 as shown in FIG. 7, a sub-data table YT2 associated with the piece of identification information BD of the operation button in the data table YT1 is also created by the controller 31 in order to measure the respective user-specific numbers of operations YN on sub-operation buttons on the sub-setting screen CP1 made by the user, and the sub-data tale YT2 is stored in the storage device 28. The elements written to the sub-data table YT2 include the piece of identification information BD of the operation button in the superior data table YT1, the piece of identification information YD of the same user as in the superior data table YT1, respective pieces of identification information BD of the sub-operation buttons, the respective functions FU of the sub-operation buttons, and the respective user-specific numbers of operations YN on the sub-operation buttons.

When the controller 31 executes processing for displaying the sub-setting screen CP1 as the function indicated by an instruction associated with the operation button operated on the home screen HP by the user, the controller 31 selects the sub-data table YT2 which is associated with the piece of identification information BD of the operation button and to which the piece of identification information YD of the user is written. When the controller 31 accepts through the touch panel 23 an instruction associated with a sub-operation button on the sub-setting screen CP1, the controller 31 determines the piece of identification information BD of the sub-operation button, reads from the selected sub-data table YT2 the function FU associated with the piece of identification information BD of the sub-operation button, and executes the read function FU. The controller 31 counts up and updates the user-specific number of operations YN on the sub-operation button in the sub-data table YT2. In this manner, the respective user-specific numbers of operations YN on the sub-operation buttons on the sub-setting screen CP1 made by the user are measured by the controller 31.

Moreover, in the case where processing for displaying a second sub-setting screen CP2 is set as the function FU of a sub-operation button in the sub-data table YT2 as shown in FIG. 7, the controller 31 creates a second sub-data table YT3 associated with the piece of identification information BD of the sub-operation button in the sub-data table YT2 superior to the data table YT3 in order to measure the respective user-specific numbers of operations YN on second sub-operation buttons on the second sub-setting screen CP2 made by the user, and allows the storage device 28 to store the data tale YT3. The elements written to the second sub-data table YT3 include the piece of identification information BD of the operation button in the sub-data table YT2 superior to the data table YT3, the piece of identification information YD of the same user as in the superior data table YT1, respective pieces of identification information BD of the second sub-operation buttons, the respective functions FU of the second sub-operation buttons, and the respective user-specific numbers of operations YN on the second sub-operation buttons.

When the controller 31 provides a display of the second sub-setting screen CP2 as the function indicated by an instruction associated with the operation button operated on the sub-setting screen CP1 by the user, the controller 31 selects the second sub-data table YT3 which is associated with the piece of identification information BD of the operation button and to which the piece of identification information YD of the user is written. When the controller 31 accepts through the touch panel 23 an instruction associated with a second sub-operation button on the second sub-setting screen CP2, the controller 31 determines the piece of identification information BD of the second sub-operation button, reads from the selected second sub-data table YT3 the function FU associated with the piece of identification information BD of the second sub-operation button, and executes the read function FU. The controller 31 counts up and updates the user-specific number of operations YN on the second sub-operation button in the second sub-data table YT3. In this manner, the respective user-specific numbers of operations YN on the second sub-operation buttons on the second sub-setting screen CP2 made by the user are measured.

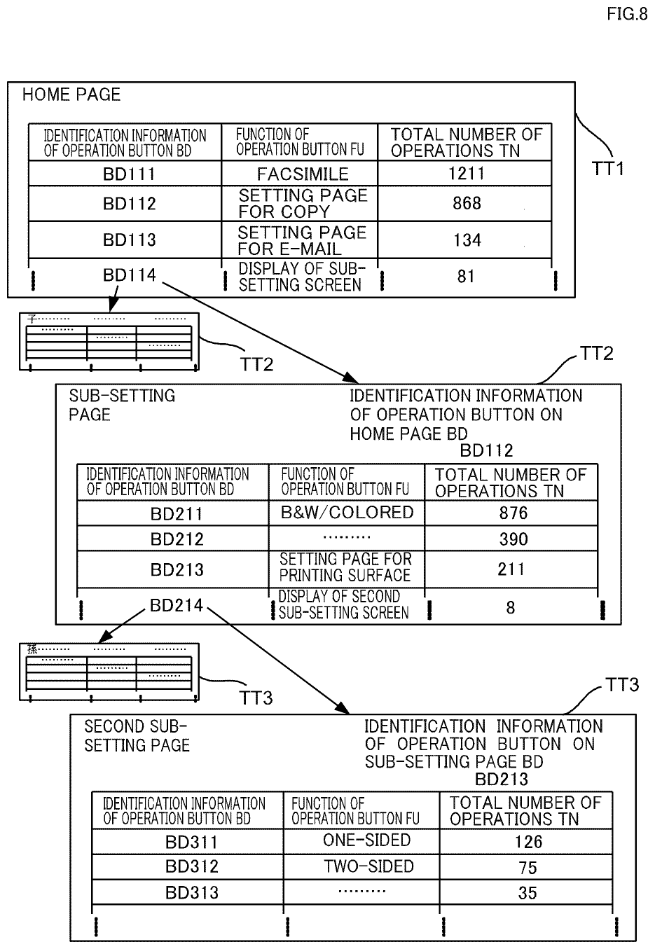

On the other hand, in measuring the respective total numbers of operations TN on the operation buttons on the home screen HP made by all the users as described previously, the controller 31 creates a data table TT1 as shown as an example in FIG. 8. The controller 31 writes the respective total numbers of operations TN on the operation buttons to the data table TT1. In the case where the image forming apparatus 10 is shared by a plurality of users without approval of the login of users to the image forming apparatus 10, the controller 31 allows the display device 21 to display a common home screen HP. When the controller 31 accepts through the touch panel 23 an instruction associated with an operation button on the home screen HP, the controller 31 identifies from the data table TT1 the function associated with the operation button and executes the function. The controller 31 counts up and updates the total number of operations TN on the operation button in the data table TT1. In this manner, the respective total numbers of operations TN on the operation buttons on the home screen HP made by all the users are measured.

Furthermore, in the case where processing for displaying a sub-setting screen CP1 is set as the function FU of an operation button in the data table TT1 as shown in FIG. 8, the controller 31 creates a sub-data table TT2 associated with the piece of identification information BD of the operation button in the data table TT1 and allows the storage device 28 to store the data tale TT2. The elements written to the sub-data table TT2 include the piece of identification information BD of the operation button in the superior data table TT1, respective pieces of identification information BD of the sub-operation buttons, the respective functions FU of the sub-operation buttons, and the respective total numbers of operations TN on the sub-operation buttons. When the controller 31 provides a display of the sub-setting screen CP1 in accordance with a user's operation on the operation button on the home screen HP, the controller 31 selects the sub-data table TT2 associated with the piece of identification information BD of the operation button. When the controller 31 detects through the touch panel 23 an operation on a sub-operation button on the sub-setting screen CP1, the controller 31 determines the piece of identification information BD of the sub-operation button, identifies from the selected sub-data table TT2 the function FU associated with the piece of identification information BD of the sub-operation button, and executes the identified function FU. The controller 31 counts up and updates the total number of operations TN on the sub-operation button in the sub-data table TT2. In this manner, the respective total numbers of operations TN on the sub-operation buttons on the sub-setting screen CP1 made by the user are measured.

Moreover, in the case where the display of a second sub-setting screen CP2 is set as the function FU of an operation button in the sub-data table TT2 as shown in FIG. 8, a second sub-data table TT3 associated with the piece of identification information BD of the operation button in the sub-data table TT2 is created and stored in the storage device 28. The elements written to the second sub-data table TT3 include the piece of identification information BD of the operation button in the sub-data table TT2, respective pieces of identification information BD of the second sub-operation buttons, the respective functions FU of the second sub-operation buttons, and the respective total numbers of operations TN on the second sub-operation buttons. When the controller 31 provides a display of the second sub-setting screen CP2 in accordance with a user's operation on the operation button on the sub-setting screen CP1, the controller 31 selects the second sub-data table TT3 associated with the piece of identification information BD of the operation button. When the controller 31 detects through the touch panel 23 an operation on a second sub-operation button on the second sub-setting screen CP2, the controller 31 determines the piece of identification information BD of the second sub-operation button, identifies from the selected second sub-data table TT3 the function FU associated with the piece of identification information BD of the second sub-operation button, and executes the identified function FU. The controller 31 counts up and updates the total number of operations TN on the second sub-operation button in the second sub-data table TT3. In this manner, the respective total numbers of operations TN on the second sub-operation buttons on the second sub-setting screen CP2 made by the user are measured.

In determining the piece of identification information BD of each operation button detected through the touch panel 23, the controller 31 determines the piece of identification information BD of the operation button associated with the location thereof detected through the touch panel 23, with reference to another data table to which the respective locations of operation buttons being displayed on the home screen and setting screens and the respective pieces of identification information BD of the operation buttons are written in association with each other.

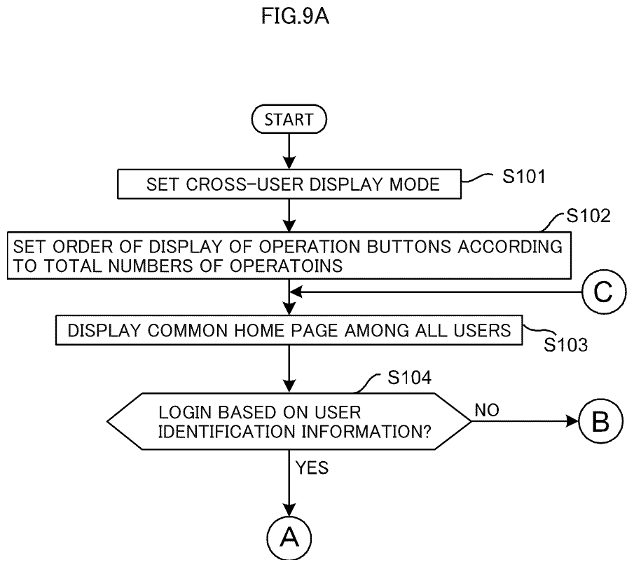

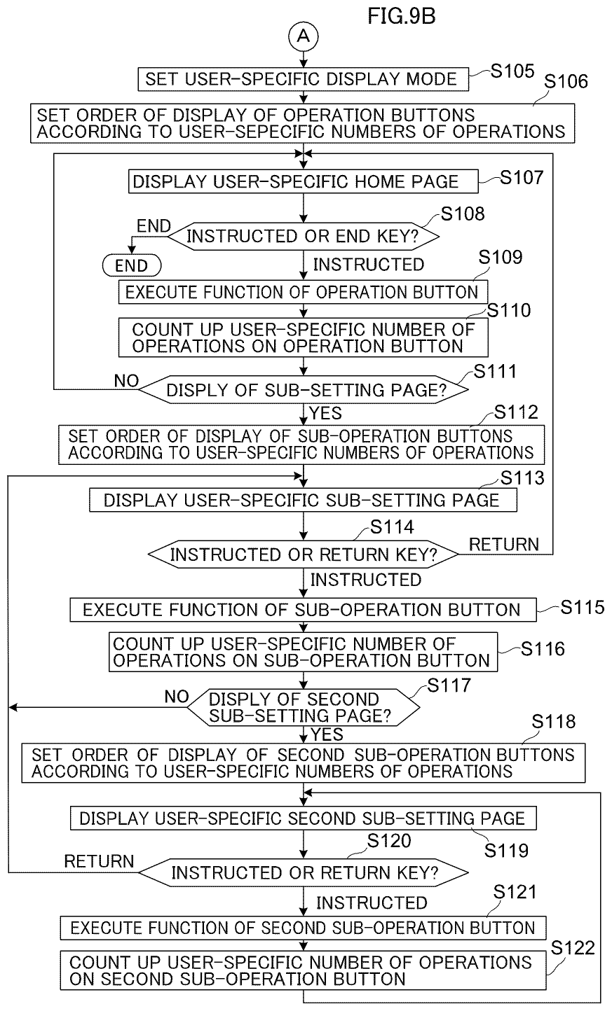

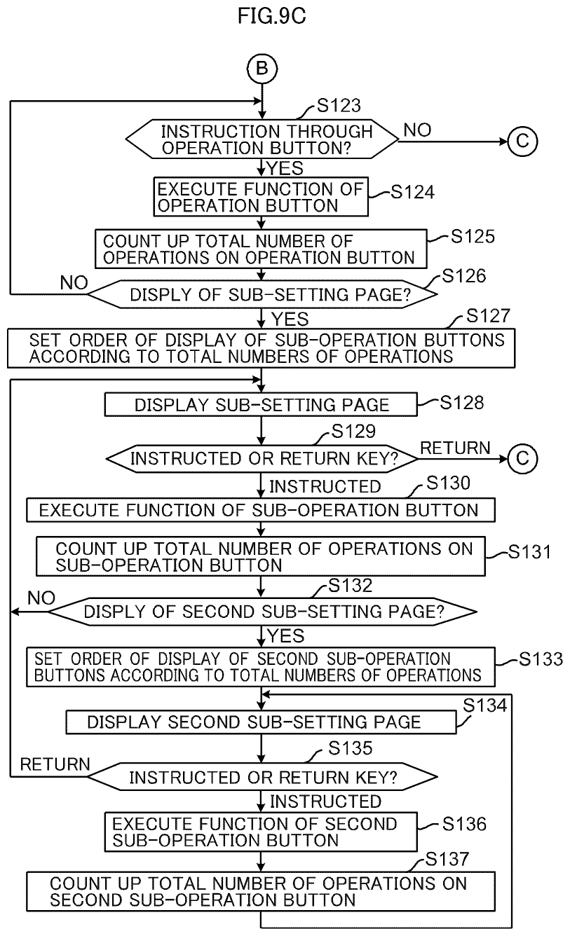

Next, a description will be given of control procedures for selectively executing either one of: the above-described user-specific display mode in which the order of display of operation buttons on each of the home screen and setting screens being displayed on the display device 21 is set based on the respective user-specific numbers of operations YN on the operation buttons; and the above-described cross-user display mode in which the order of display of the operation buttons on each of the home screen and setting screens is set based on the respective total numbers of operations TN on the operation buttons made by all the users, with reference to the flowcharts shown in FIGS. 9A, 9B, and 9C.

When an instruction to select the cross-user display mode is accepted by the operation device 22, the controller 31 sets the image forming apparatus 10 to the cross-user display mode (S101). The controller 31 sets, based on the data table TT1 shown in FIG. 8, the order of the operation buttons to arrange them in descending order of total number of operations TN (S102) and allows the operation buttons to be displayed in this order on the home screen HP (S103). For example, in this embodiment, in the case of the home screen HP shown in FIG. 3A, the controller 31 arranges the operation buttons with those having larger total numbers of operations TN in upper rows and arranges, in each row, operation buttons in descending order of total number of operations TN from left to right. Thus, the operation buttons are arranged exactly in descending order of total number of operations TN, which makes the home screen HP user-friendly for all the users.

Then, when the controller 31 does not approve the login of the user (“No” in S104), it keeps the cross-user display mode and the display of the home screen HP in S103.

On the other hand, when the piece of identification information YD of the user is read by the card reader 24 and the controller 31 approves the login of the user (“Yes” in S104), the controller 31 switches and sets the mode of the image forming apparatus 10 to the user-specific display mode (S105).

When the user-specific display mode is set (S105), the controller 31 selects a data table YT1 to which the piece of identification information YD of the logged-in user is written, sets, based on the respective pieces of identification information BD of the operation buttons in the data table YT1, the order of the operation buttons to arrange them in descending order of user-specific number of operations YN (S106), and allows the operation buttons to be displayed in this order on the home screen HP (S107). Thus, the home screen HP is made user-friendly for the logged-in user.

The controller 31 waits for a touch gesture on any one of the operation buttons or an End key EK (see FIG. 3) on the home screen HP. When accepting through the touch panel 23 an instruction associated with an operation button (“Instructed” in S108), the controller 31 determines the piece of identification information BD of the operated operation button, identifies from the selected data table YT1 the function FU associated with the piece of identification information BD of the operation button, and executes the function FU (S109). The controller 31 counts up and updates the user-specific number of operations YN on the operation button in the data table YT1 (S110).

When the controller 31 determines that the function FU executed in S109 is not the display of a sub-setting screen CP1 (“No” in S111), the processing goes back to S107. In doing so, the user-specific number of operations YN on the operation button is updated in S110, but the controller 31 does not change the order of display of the operation buttons while the home screen HP is operated. Thus, it can be prevented that the user is confused about the operations of the operation buttons by an abrupt change in display order.

On the other hand, when the controller 31 determines that the function FU executed in S109 is the display of a sub-setting screen CP1 (“Yes” in S111), the controller 31 sets, based on the respective pieces of identification information BD of operation buttons in a sub-data table YT2 to which the piece of identification information BD of the operation button on the home screen HP determined in S108 and the piece of identification information YD of the same user as in the superior data table YT1 for use in creating the user-friendly home screen HP are written, a layout of operation buttons arranged in descending order of user-specific number of operations YN in the sub-data table YT2 updated by the execution of the above function FU (S112), and allows the display device 21 to display the sub-setting screen CP1 in which the operation buttons are arranged in the above layout (S113). Thus, the sub-setting screen CP1 is also made user-friendly for the user.

The controller 31 waits for an input of an instruction associated with any one of the sub-operation buttons or a Return key RK (see FIG. 4) on the sub-setting screen CP1 (S114). When accepting through the touch panel 23 an instruction associated with a sub-operation button (“Instructed” in S114), the controller 31 determines the piece of identification information BD of the operated sub-operation button, identifies from the sub-data table YT2 the function FU associated with the piece of identification information BD of the sub-operation button, and executes the function FU (S115). The controller 31 counts up and updates the user-specific number of operations YN on the sub-operation button in the sub-data table YT2 (S116).

The controller 31 determines whether or not the function FU executed in S115 is processing for displaying a second sub-setting screen CP2 (S117). When determining that the executed function FU is not the display of a second sub-setting screen CP2 (“No” in S117), the processing goes back to S113. In doing so, the user-specific number of operations YN on the sub-operation button is updated in S116, but the controller 31 does not change the order of display of the sub-operation buttons while the sub-setting screen CP1 is operated.

On the other hand, when in S114 the controller 31 accepts through the touch panel 23 an instruction associated with the Return key RK (see FIG. 4) (“Return” in S114), the processing goes back to S107 and the controller 31 allows the display device 21 to display the user-friendly home screen HP again. Thereafter, the processing in S107 to S114 is repeated.

When the function FU executed in S115 is processing for displaying a second sub-setting screen CP2 (“Yes” in S117), the controller 31 sets, based on the respective pieces of identification information BD of operation buttons in a second sub-data table YT3 to which the piece of identification information YD of the logged-in user is written, a layout of operation buttons arranged in descending order of user-specific number of operations YN (S118), and allows the display device 21 to display the second sub-setting screen CP2 in which the operation buttons are arranged in the above layout (S119). Thus, the second sub-setting screen CP2 is also made user-friendly for the user.

The controller 31 waits for a touch gesture on any one of the second sub-operation buttons or a Return key RK (see FIGS. 5 and 6) on the second sub-setting screen CP2 (S120). When accepting through the touch panel 23 an instruction associated with a second sub-operation button (“Instructed” in S120), the controller 31 identifies from the selected second sub-data table YT3 the function FU associated with the piece of identification information BD of the second sub-operation button and executes the function FU (S121). The controller 31 counts up and updates the user-specific number of operations YN on the second sub-operation button in the second sub-data table YT3 (S122). In doing so, the user-specific number of operations YN on the second sub-operation button is updated, but the controller 31 does not change the order of display of the second sub-operation buttons while the second sub-setting screen CP2 is operated.

After S122, the processing goes back to S119. When accepting through the touch panel 23 an instruction associated with another second sub-operation button (“Instructed” in S120), the controller 31 repeats the processing in S121 and S122.

On the other hand, when no touch gesture is made on another second sub-operation button and the controller 31 accepts through the touch panel 23 an instruction associated with the Return key RK (“Return” in S120), the processing goes back to S113. The controller 31 allows the display device 21 to display the user-friendly sub-setting screen CP1 again.

As described previously, when in S114 the controller 31 accepts through the touch panel 23 an instruction associated with the Return key RK (see FIG. 4) (“Return” in S114), the processing goes back to S107, the controller 31 allows the display device 21 to display the user-friendly home screen HP again, and the processing in S107 to S114 is repeated. However, when the controller 31 accepts through the touch panel 23 an instruction associated with the End key EK (see FIG. 3) on the home screen HP (“End” in S108), the controller 31 hides the user-friendly home screen HP. Thereafter, the processing ends.

In a state where the controller 31 does not approve the login of the user (“No” in S104) and keeps the cross-user display mode and the display of the home screen HP in S103, the controller 31 waits for an input of an instruction associated with any one of the operation buttons on the home screen HP (S123). When in this state the controller 31 accepts through the touch panel 23 an instruction associated with an operation button (“Yes” in S123), the controller 31 identifies from the data table TT1 the function FU associated with the piece of identification information BD of the operation button and executes the function FU (S124). The controller 31 counts up and updates the total number of operations TN on the operation button in the data table TT1 (S125).

Then, the controller 31 determines whether or not the function FU executed in S124 is processing for displaying a sub-setting screen CP1 (S126). When the executed function FU is not the display of a sub-setting screen CP1 (“No” in S126), the processing goes back to S123. In doing so, the total number of operations TN on the operation button is updated in S125, but the controller 31 does not change the order of display of the operation buttons while the home screen HP is operated.

On the other hand, when the function FU executed in S124 is processing for displaying a sub-setting screen CP1 (“Yes” in S126), the controller 31 sets, based on the respective pieces of identification information BD of operation buttons in a sub-data table TT2 associated with the piece of identification information BD of the operation button on the home screen HP determined in S124, a layout of operation buttons arranged in descending order of total number of operations TN in the sub-data table TT2 (S127). The controller 31 allows the display device 21 to display the sub-setting screen CP1 in which the operation buttons are arranged in the above layout (S128). Thus, the sub-setting screen CP1 is made user-friendly for all the users.

The controller 31 waits for an input of an instruction associated with any one of the sub-operation buttons or a Return key RK on the sub-setting screen CP1 (S129). When accepting through the touch panel 23 an instruction associated with a sub-operation button (“Instructed” in S129), the controller 31 identifies from the selected sub-data table TT2 the function FU associated with the piece of identification information BD of the sub-operation button and executes the function FU (S130). The controller 31 counts up and updates the total number of operations TN on the sub-operation button in the sub-data table TT2 (S131).

Subsequently, the controller 31 determines whether or not the function FU executed in S130 is processing for displaying a second sub-setting screen CP2 (S132). When the executed function FU is not the display of a second sub-setting screen CP2 (“No” in S132), the processing goes back to S128. In doing so, the total number of operations TN on the sub-operation button is updated in S131, but the controller 31 does not change the order of display of the sub-operation buttons while the sub-setting screen CP1 is operated.

Then, when no touch gesture is made on another sub-operation button and the controller 31 accepts through the touch panel 23 an instruction associated with the Return key RK (“Return” in S129), the processing goes back to S103 and the controller 31 allows the display device 21 to display the common home screen HP again. Thereafter, the processing in S103 and the subsequent steps is repeated.

On the other hand, when the function FU executed in S130 is processing for displaying a second sub-setting screen CP2 (“Yes” in S132), the controller 31 sets, based on the respective pieces of identification information BD of operation buttons in a second sub-data table TT3 associated with the piece of identification information BD of the sub-operation button on the sub-setting screen CP1 determined in S130, a layout of operation buttons arranged in descending order of total number of operations TN (S133) and allows the display device 21 to display the second sub-setting screen CP2 in which the operation buttons are arranged in the above set layout (S134). Thus, the second sub-setting screen CP2 is made user-friendly for all the users.

The controller 31 waits for an input of an instruction associated with any one of the second sub-operation buttons or a Return key RK on the second sub-setting screen CP2 (S135). When accepting through the touch panel 23 an instruction associated with a second sub-operation button (“Instructed” in S135), the controller 31 identifies from the selected second sub-data table TT3 the function FU associated with the piece of identification information BD of the second sub-operation button and executes the function FU (S136). The controller 31 counts up and updates the total number of operations TN on the second sub-operation button in the second sub-data table TT3 (S137).

Thereafter, the controller 31 goes back to S134 and waits for an input of an instruction associated with another second sub-operation button or the Return key RK (S135). When accepting through the touch panel 23 an instruction associated with another second sub-operation button (“Instructed” in S135), the controller 31 repeats the processing in S136 and S137.

On the other hand, when no touch gesture is made on another second sub-operation button and the controller 31 accepts through the touch panel 23 an instruction associated with the Return key RK (“Return” in S135), the processing goes back to S128. The controller 31 allows the display device 21 to display the sub-setting screen CP1 again.

Then, when the controller 31 accepts through the touch panel 23 an instruction associated with the Return key RK (“Return” in S129), the processing goes back to S103. The controller 31 allows the display device 21 to display the common home screen HP again.

As thus far described, in this embodiment, either one of the following display modes is selectively executed: (a) a user-specific display mode in which, for each individual one of users, respective user-specific numbers of operations YN on operation buttons made by the individual user are measured and, in use by the individual user, the order of display of the operation buttons on each of the home screen and setting screens displayed on the display device 21 is set based on the measured respective user-specific numbers of operations YN on the operation buttons; and (b) a cross-user display mode in which respective total numbers of operations TN on the operation buttons made by all the users are measured and, in use by any user, the order of display of the operation buttons on each of the home screen and setting screens is set based on the measured respective total numbers of operations TN on the operation buttons. Therefore, the plurality of operation buttons can be displayed in an order of display in which not only the logged-in user but also many and unspecified persons can easily operate these operation buttons.

A s just described, in this embodiment, the order of display of operation buttons is set based on the respective user-specific numbers of operations YN on the operation buttons or the respective total numbers of operations TN on the operation buttons. However, in some cases, fixing the places of operation buttons in the order of display, regardless of the numbers of operations on the operation buttons, makes the operation buttons easier to operate. For this reason, in another embodiment, in controlling the display in the user-specific display mode, the controller 31 excludes an operation button specified by a button place fixing instruction to fix the place of the button in the order of display, the instruction having been input to the operation device 22, from the scope of the processing for setting the order of display of operation buttons based on the numbers of operations and allows the display device 21 to display the specified operation button to fix it in the place in the order of display as it has been displayed at the time of input of the button place fixing instruction.

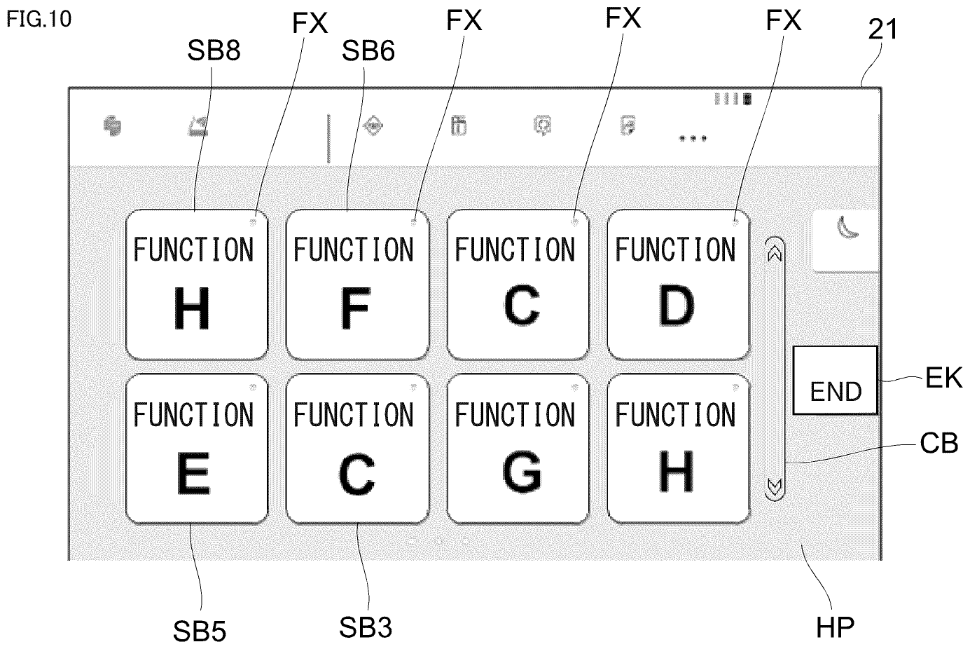

For example, as shown in FIG. 10, the controller 31 allows the display device 21 to display at a corner of each operation button a mark FX through which an input of a button place fixing instruction to fix the place of the operation button in the order of display is accepted.

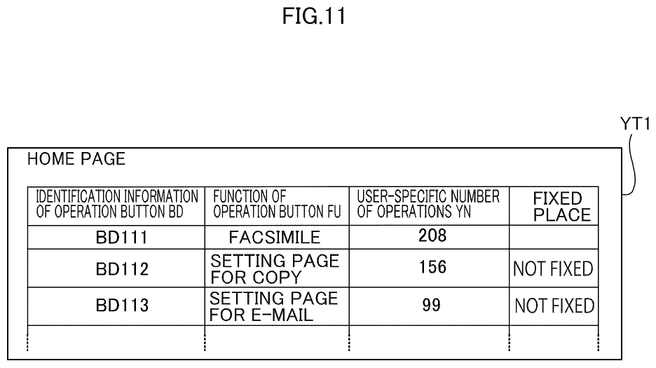

Furthermore, as shown as an example in FIG. 11, the data table YT1 stored in the storage device 28 is provided with a “Fixed Place” item showing, for each operation button, whether or not the place of the operation button in the order of display is fixed or its place in the order of display when fixed.

When a user makes a touch gesture on the mark FX of any one of the operation buttons during display of the display device 21 as shown in FIG. 10, the controller 31 accepts through the touch panel 23 a button place fixing instruction to fix the current place of the operation button in the order of display. Then, the controller 31 designates, in accordance with the button place fixing instruction, the place of the operation button the mark FX on which has been operated as a fixed place in the order of display and writes, to the field of the “Fixed Place” item associated with the piece of identification information BD of the operation button in the data table YT1, information designating the place of the operation button in the order of display at the time of acceptance of the button place fixing instruction as a fixed place in the order of display.

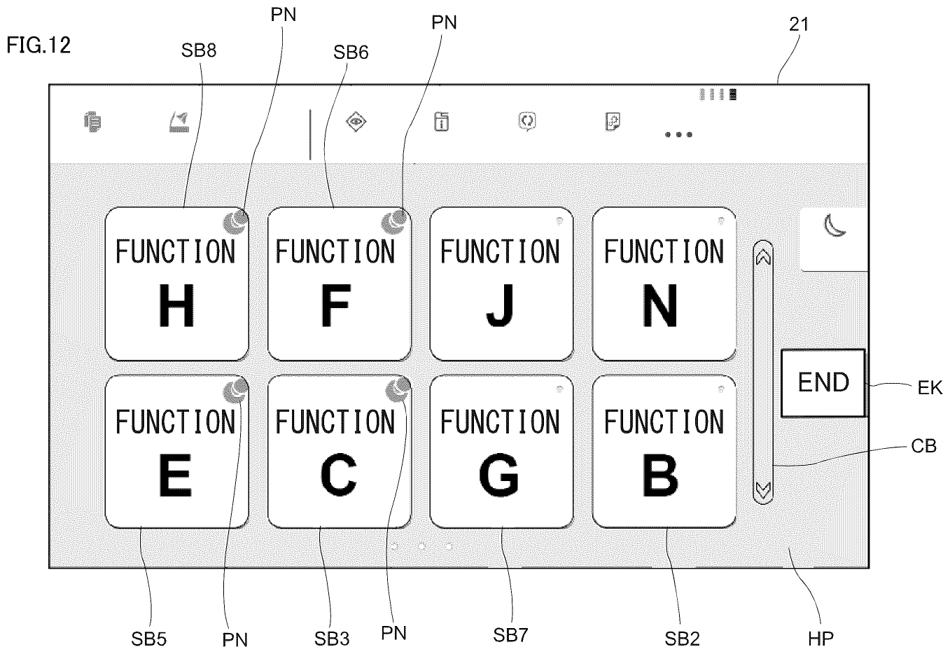

In executing the above-described processing in S106, the controller 31 sets the order of display of operation buttons on the home screen HP by setting, as for operation buttons the fixed places of which in the order of display are described in the fields of the above “Fixed Place” item, their places in the order of display to the described fixed places and setting, as for the other operation buttons the places of which in the order of display are not described (or described as “Not fixed”) in the fields of the above “Fixed Place” item, the order of display of them to descending order of user-specific number of operations YN. The controller 31 allows the display device 21 to display the home screen HP in which the operation buttons are arranged in the order of display set as above, as shown as an example in FIG. 12. In doing so, the controller 31 may allow the display device 21 to display the operation buttons displayed in the fixed places in the order of display, together with affixed predetermined images representing that the operation buttons are displayed according to the fixed places, for example, pin-type images PN representing thumbtacks in this embodiment. Thus, the user-designated operation buttons are displayed in fixed places on the home screen HP.

Also regarding the sub-setting screen CP1 and the second sub-setting screen CP2, the controller 31 designates, in accordance with an operation on a mark FX affixed to the corner of any operation button, the current place of the operation button as a fixed place in the order of display and writes the fixed place in the order of display to the data tables YT2 and YT3 in association with the piece of identification information BD of the operation button. Then, in executing the above-described processing in each of S112 and S118, the controller 31 sets the order of display of operation buttons on each of the sub-setting screen CP1 and the second sub-setting screen CP2 by setting, as for operation buttons the fixed places of which in the order of display are described in the fields of the above “Fixed Place” item, their places in the order of display to the described fixed places and setting, as for the other operation buttons the places of which in the order of display are not described (or described as “Not fixed”) in the fields of the above “Fixed Place” item, the order of display of them to descending order of user-specific number of operations YN. The controller 31 allows the display device 21 to display the sub-setting screen CP1 and the second sub-setting screen CP2 in which the operation buttons are arranged in the order of display set as above.

The above-described processing of the controller 31 for fixing the place of each operation button in the order of display may be executed in the cross-user display mode. In doing so, the controller 31 may allow the display device 21 to display operation buttons displayed in the fixed places in the order of display, together with affixed predetermined images representing that the operation buttons are displayed according to the fixed places, for example, pin-type images PN representing thumbtacks in this embodiment.

Although the above embodiment takes as an example the image forming apparatus 10 to which a display input device according to one embodiment of the present disclosure is applied, a display input device according to the present disclosure can be applied to other types of electronic equipment, including a personal computer, a mobile device, and a mobile phone.

In calculating the total number of operations TN on each operation button made by all the users, the controller 31 may calculate it by adding up the respective user-specific numbers of operations YN on the operation button measured on the basis of individual users.

The structure, configuration, and processing of the above embodiments described with reference to FIGS. 1 to 12 are merely illustrative and are not intended to limit the present disclosure to them.

In a display input device not according to any of the above embodiments, it is applied to, for example, an image forming apparatus, wherein respective operation buttons associated with a plurality of functions of the image forming apparatus are displayed. When any one of the operation buttons is operated, the image forming apparatus executes the function associated with the operated operation button. The image forming apparatus has a wide variety of functions and thus has a large number of operation buttons subject to being displayed. Therefore, these operation buttons should preferably be displayed in an order in which the user can easily operate them.

There are known: (a) a technique for simply displaying functions highly used by a logged-in user on a touch panel display and, upon subsequent selection and determination of one of the displayed functions, displaying functions highly combined with the determined function as recommendations on the touch panel display, and presenting a combination of these functions to the logged-in user; and (b) a technique for simply storing a usage history of functions on a user-by-user basis, determining a recommended function based on the usage history, and notifying the user of the recommended function. However, in most of image forming apparatuses shared by many and unspecified persons, a login procedure of users is omitted, in which case it is not useful to display functions or a combination of functions for each individual user. Furthermore, if an individual person edits operation buttons to be displayed on the display input device, this may make it hard for the other persons to use the operation buttons. Unlike the above, in the above embodiments, whether the image forming apparatus is operated by a logged-in user or any one of many and unspecified persons, a plurality of operation buttons can be displayed in an order in which they can easily operate the operation buttons.

While the present disclosure has been described in detail with reference to the embodiments thereof, it would be apparent to those skilled in the art that the various changes and modifications may be made therein within the scope defined by the appended claims.

What is claimed is:

1. A display input device comprising:
a display device that displays a plurality of operation buttons associated with different functions;
an input device that is capable of being operated by a plurality of users and accepts an input of an instruction associated with each of the operation buttons displayed on the display device; and
a controller that, upon input of the instruction associated with the operation button to the input device, executes the function associated with the operation button,
wherein the controller controls display of the display device in either one of:
a user-specific display mode in which, for each individual one of the users, respective user-specific numbers of operations on the operation buttons made by the individual user are measured and an order of display of the operation buttons on the display device for the individual user is set based on the measured respective user-specific numbers of operations on the operation buttons; and
a cross-user display mode in which respective total numbers of operations on the operation buttons made by all the users are measured and an order of display of the operation buttons on the display device is set as a common order of display among all the users based on the measured respective total numbers of operations on the operation buttons.

2. The display input device according to claim 1, wherein in controlling the display in the cross-user display mode, the controller excludes the operation button specified by a button place fixing instruction to fix a place of the button in the order of display, the instruction having been input to the input device, from a scope of processing for setting the order of display of the operation buttons based on the numbers of operations and allows the display device to display the specified operation button to fix the specified operation button in a place in the order of display as the specified operation button has been displayed at a time of input of the button place fixing instruction.

3. The display input device according to claim 2, wherein while the controller allows the display device to display the operation button specified by the button place fixing instruction to fix the operation button in the place in the order of display as the operation button has been displayed at the time of input of the button place fixing instruction, the controller allows the display device to display, on the operation button displayed in the fixed place, a predetermined image representing that the operation button is displayed according to the fixed place.

4. The display input device according to claim 1, wherein in controlling the display in the user-specific display mode, the controller excludes the operation button specified by a button place fixing instruction to fix a place of the button in the order of display, the instruction having been input to the input device, from a scope of processing for setting the order of display of the operation buttons based on the numbers of operations and allows the display device to display the specified operation button to fix the specified operation button in a place in the order of display as the specified operation button has been displayed at a time of input of the button place fixing instruction.

5. The display input device according to claim 1, wherein
when the instruction associated with the operation button is input to the input device, the controller allows the display device to display a plurality of sub-operation buttons subordinated to the operation button,
when an instruction associated with one of the sub-operation buttons is input to the input device, the controller executes a function associated with the sub-operation button, and
the controller controls the display of the display device in either one of:
a user-specific display mode in which, for each individual one of the users, respective user-specific numbers of operations on the sub-operation buttons made by the individual user are measured and an order of display of the sub-operation buttons on the display device for the individual user is set based on the measured respective user-specific numbers of operations on the sub-operation buttons; and
a cross-user display mode in which respective total numbers of operations on the sub-operation buttons made by all the users are measured and an order of display of the sub-operation buttons on the display device is set as a common order of display among all the users based on the measured respective total numbers of operations on the sub-operation buttons.

6. The display input device according to claim 1, wherein the controller calculates the total number of operations on each of the operation buttons made by all the users, based on the respective user-specific numbers of operations on the operation button measured on a basis of individual users.

7. A display input device comprising:
a display device that displays a plurality of operation buttons associated with different functions;
an input device that is capable of being operated by a plurality of users and accepts an input of an instruction associated with each of the operation buttons displayed on the display device; and
a controller that, upon input of the instruction associated with the operation button to the input device, executes the function associated with the operation button,
wherein the controller controls display of the display device in a cross-user display mode in which respective total numbers of operations on the operation buttons made by all the users are measured and an order of display of the operation buttons on the display device is set as a common order of display among all the users based on the measured respective total numbers of operations on the operation buttons, and
in controlling the display in the cross-user display mode, the controller excludes the operation button specified by a button place fixing instruction to fix a place of the button in the order of display, the instruction having been input to the input device, from a scope of processing for setting the order of display of the operation buttons based on the numbers of operations and allows the display device to display the specified operation button to fix the specified operation button in a place in the order of display as the specified operation button has been displayed at a time of input of the button place fixing instruction.

8. An image forming apparatus comprising:
the display input device according to claim 1; and
an image forming device that forms an image on a recording paper sheet.
